(19) United States
(12) Patent Application Publication
(10) Pub. No.: US 2012/0144025 A1
(43) Pub. Date: Jun. 7, 2012

(54) Method and an Arrangement For Enabling User Traffic Classification Configuration

(75) Inventors: Bob Melander, Sigtuna (SE); Christofer Flinta, Stockholm (SE); Jan-Erik Mangs, Solna (SE)

(73) Assignee: Telefonaktiebolaget L.M. Ericsson (publ), Stockholm (SE)

(21) Appl. No.: 13/141,414

(22) PCT Filed: Dec. 23, 2008
(86) PCT No.: PCT/SE2008/051556

§ 371 Date: Jul. 25, 2011

(51) Int. Cl. G06F 15/173

(52) U.S. Cl. 709/224

(57) ABSTRACT

A method of enabling traffic flow classification on a node, which may be used for controlling the traffic flows on the same node or on another node of a communication network. A first mapping process is configured to manage an operation for linking an application process to a class, and a second mapping process is configured to manage an operation for linking an application process to a unique signature. A third mapping process is configured to manage a record of accumulated linking information, such that a traffic flows associated with an application process may be identified and such that a classification of the respective traffic flow can be recognised. The accumulated classification information may then be used for controlling purposes.

### TECHNICAL FIELD

The present invention relates to a method and an arrangement for enabling classification of traffic flows at a traffic generating node connected to a communications network. The present invention also relates to a method and an arrangement for controlling traffic flows on the basis of a specified classification.

### BACKGROUND

Today IP traffic is used for a large amount of information distribution. In order to be able to manage IP network traffic generated by an application in a controlled way, e.g. such that the traffic flows can be forwarded by network nodes according to certain rules and/or priorities, the traffic flows have to be classified accordingly. Such a task may be executed either at the very same node from where the traffic is generated, or at any type of intermediate network node, such as e.g. a home gateway, a residential gateway, a access node, a switch, a router or a Broadband remote Access Server (BRAS).

The US patent application US 2006 0251234 refers to a method for enabling an end-user to manage bandwidth reservation in a communication network, according to different options. According to the document, an end-user is provided with a turbo button service which enables the end-user to request for additional bandwidth from the network provider when needed. An invocation of the request results in a change of a present default bandwidth allocated to the user's access connection to a bandwidth that meets the requirements. The bandwidth management method is however not adapted to enable traffic flows classification of different traffic flows.

Classification of traffic flows can be particularly challenging in situations, such as e.g. in the common situation where an application is generating traffic flows with random port numbers. In order to enable identification of a traffic flow at a forwarding node, the forwarding node will typically be required to look into the payload of each arriving packet. This mechanism, which, in addition to being time consuming, is CPU intensive, and requires knowledge about the application protocol, is commonly referred to as deep packet inspection.

A residential access link, which may typically be an ADSL link, is often a bandwidth bottleneck in an end-to-end path between an end-user terminal and a server, which are typically connected to each other via the Internet. How such a resource is managed by the nodes involved in the connection may have considerable impact on the total end-to-end experience.

A great deal of the IP traffic passing residential access links today is carried by TCP and, thus, this type of traffic is of an adaptive nature. A consequence from this is that the utilization of such an access link to a large extent can be controlled by a residential gateway, or a home gateway, not only in the upstream direction but also fairly effectively in the downstream direction.

Commodity home gateways of today typically have some support to control its access links, e.g. by allowing certain traffic flows relating to applications, such as e.g. online games, to be prioritized over other types of traffic flows, such as e.g. FTP file transfers.

Although modern home gateways usually have some support for Quality of Service (QoS) control of an access link, the configuration of such mechanisms are typically cumbersome, especially for people with limited computer skills. A configuration usually involves logging in to the home gateway via a web browser and finding the settings that need to be changed for obtaining a required QoS. Such settings may e.g. involve specifying certain ports and protocols.

Even if the end-user is able to complete such a configuration successfully, the QoS mechanism may still fail if the controlled traffic flows cannot be correctly classified. This may be the case e.g. when a network application uses random port numbers for its generated traffic flows. In such a situation, where port numbers may be changed more or less frequently, it may be very difficult, and in some situations even impossible, to efficiently maintain control over the access link.

Hence, while the access link could, in theory, benefit from localized QoS mechanisms, those mechanisms may in real life be inapplicable in the network because the intermediate nodes are unable to efficiently classify the different traffic flows. One reason for this is that the intermediate network nodes are unable not only to provide a mechanism that enables traffic flow classification in a user friendly way, but also to maintain classification information updated throughout a session.

### SUMMARY

It is an object of the present invention to address at least some of the problems mentioned above. More specifically the present invention relates to a method for generating and updating information that can be used for classifying traffic flows, and nodes that are configured for executing the suggested method.

According to one aspect, a method of classifying traffic flows in a node, which may be referred to as a traffic generating node, and where each traffic flow is associated with an application process running on the node, is provided.

The method comprises the step of performing a first mapping operation, which is configured to link an application process to a class in response to having registered a selection or change of class for the application process.

The method also comprise another step of performing a second mapping operation, which is configured to link an application process to a signature that uniquely identifies a traffic flow and an associated socket in response to having registered an activity for the socket.

The method is also configured to activate a third mapping operation, such that a respective signature is linked to the respective class in response to having registered an activity associated with said first or second mapping operation that involves an active or closing application process. The three operations enables accumulation of information on executed signature to class linking procedures, which may be used for controlling the classified traffic flows.

The first mapping operation may typically be executed according to a default classification, which may be applied until a user chooses another class for a respective application process. A selection of class for a respective application process may be achieved in a very user friendly way where a user may drag an icon that corresponds to an application to a class related symbol, or between two different class related symbols, on a user interface, and where the user may the drop the icon on a class related symbol that represents a required class.

According to one embodiment, a selected class may be associated with at least one rule, which is specifying at least one condition, associated with a traffic flow that is linked to the respective class.

According to another embodiment, a selected class may instead be associated with a priority, specifying how a traffic flow that is linked to said class is to be prioritized.

The second mapping operation may be configured to collect information associated with an activated socket, to generate a signature associated with a respective application process on the basis of the collected information, and to store the signature in a dedicated list together with an identifier, identifying the respective application process, in response to recognising a created socket. If it is instead determined that a socket associated with an application process has been removed, the second mapping operation may be configured to remove a respective entry from the respective list.

In a typical embodiment, a signature may comprise protocol information, the source IP address, the source port, the destination IP address and the destination port, associated with the respective socket.

The third mapping operation may be configured to store the result of a mapping in dedicated list, in case it is determined that a new mapping has been executed, or a present mapping has been updated, and to remove a respective entry from the list, in case it is determined that a socket has been closed, or a class has been cancelled for an application process.

On the basis of accumulated content of the list managed by the third mapping operation, one or more traffic flows may be controlled

As an alternative to managing classification information at the traffic generating node, the third mapping operation may instead be configured to provide classification information to another node, enabling such a node to control traffic flows on the basis of the classification information. Such a procedure may be configured such that the traffic generating node is configured to generate a notification, comprising the signature to class linking or an indication that a linking has been removed from a list managed by the first or second mapping operation, and to transmit the notification to at least one server, thereby enabling accumulation of information on the linking of signature to class at the server.

According to another aspect, a method for controlling at least one traffic flow on the basis of linked signature to class information accumulated at a server is provided. Furthermore, a server configured to execute such a method is provided.

According to yet another embodiment, a traffic generating node that has been configured to execute the method according to any of the embodiments suggested above, is provided.

The proposed classification mechanism enables users to modify and maintain classification in a simplified way. In addition, the suggested mechanism provides for a simple and robust controlling mechanism, which will be based on the classification information.

Further features of the suggested method, and nodes configured to execute such a method, and associated benefits will be explained in the detailed description below.

### BRIEF DESCRIPTION OF THE DRAWINGS

The present invention will now be described in more detail by way of non-limiting examples and with reference to the accompanying drawings, in which:

FIG. 1 is a general overview of a client, configured for classifying traffic flows and a server, configured to maintain classification information.

FIG. 2 is a general flow chart, illustrating a method for enabling traffic flow classification, and for maintaining such classification information updated and accessible for controlling purposes.

FIG. 3 is a block scheme, illustrating a traffic generating node comprising a client, according to one embodiment, that is configured to execute the classification method described with reference to FIG. 2.

FIG. 4 is another block scheme, illustrating a server comprising a traffic controller, that is configured to update and process classification data obtained from a traffic generating node.

FIG. 5 is yet another block scheme, illustrating a traffic generating node/client, according to another embodiment, that has been adapted to manage the classification method described with reference to FIG. 2.

FIG. 6 is another block scheme, illustrating a mapping manager of a traffic generating node, according to one exemplifying embodiment.

FIG. 7 is an illustration of a typical example of a manually executed classification or prioritization of an application.

FIG. 8 is a block scheme, illustrating a signature engine of a traffic generating node, according to one exemplifying embodiment.

FIG. 9 is a flow chart, illustrating a method at a traffic generating node for executing a priority management process, according to one embodiment.

FIG. 10 is another flow chart, illustrating a method at a traffic generating node for executing an application to signature mapping, according to one embodiment.

FIG. 11 is yet another flow chart, illustrating a method at a server for receiving, updating mapping information from a traffic generating node, and for using this information for controlling purposes, according to one embodiment.

### DETAILED DESCRIPTION

Briefly described, a method and an arrangement for enabling traffic flow classification are suggested. Such a traffic flow classification may be based e.g. on prioritization, or any other predefined rules, specifying how traffic flows associated with application processes which are run on a traffic generating node are to be handled. By maintaining such classification information updated, this information may be used for the purpose of controlling traffic flows.

In the described context, a traffic generating node may comprise any type of entity on which applications can be executed and which is engaged in any type of communication with at least one other node. Such a traffic generating node may e.g. be any of a laptop, a PC, a mobile station, a PDA, a set top box, a television set, a game console, or a network kitchen appliance.

The obtained classification information may be used either locally on the traffic generating node, or distributed, on any other network node, to which updated classification information has been forwarded. Such a classification mechanism will be described in further detail below with reference to different aspects and embodiments.

The suggested classification mechanism is based on the principle that applications that are available and executable on a traffic generating node are appointed a respective class, either as a result of a user interaction, and/or by dedicating an application a certain class, according to a default list, and that this application to class mapping is maintained in a list, from hereinafter referred to as a class mapping list.

By continuously updating this class mapping list, the maintained information can be used for controlling and/or managing traffic flows in a range of different embodiments, without requiring any further interaction from an end-user, and without the end-user having to be updated about traffic flow related changes, such as e.g. changing port numbers. The suggested classification mechanism may be applied on a number of different types of traffic generating nodes.

In addition, in order for a distributed processing element, or for a processing element located at the traffic generating node itself, to be able to control traffic flows on the basis of the classification information, an application to traffic flow mapping procedure to be applied at the traffic generating node, is also suggested.

By repeatedly updating changes associated with one or more applications of the traffic generating node, and by making updated mapping information available to a processing element in response to such a change, the processing element, which may be an element that is integrated with the traffic generating node, or a distributed, stand-alone entity, such as e.g. a home gateway or a residential gateway, a access node, a switch, a router or a Broadband remote Access Server (BRAS), will be able to handle each traffic flow originating from, or destined to, the traffic generating node according to the classification, and, thus, to control the traffic flows in a much more efficient and reliable way than what is possible with alternative conventional solutions.

It is to be understood that typically the traffic generating node is not restricted to a node that only transmits traffic, but that is adapted both to send traffic to, and receive traffic from various nodes of a communication network.

A classification system that is adapted to maintain the suggested mapping information, and to provide the classification information to a distributed processing element may be schematically described with a simplified client and server model.

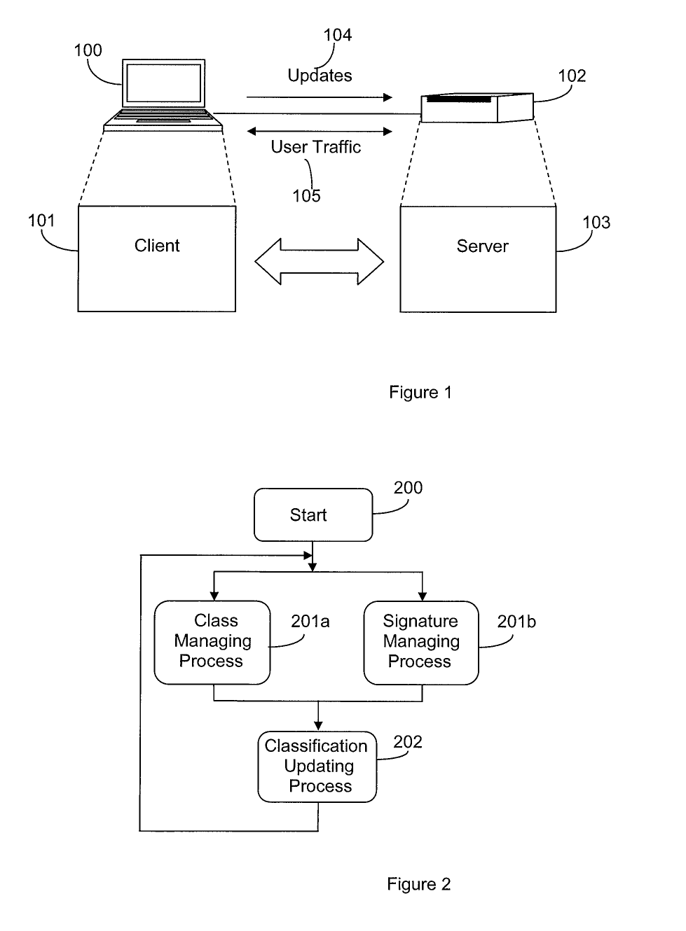

A simplified flow chart illustrating such a configuration is shown in FIG. 1, where an end-user terminal, or a traffic generating node 100, that is used by an end-user for executing one or more applications, comprises a Client 101 that is adapted to enable the end-user to define a class for one or more applications that are available on the traffic generating node, and a network node 102, having a server functionality 103, that is configured to execute some kind of traffic flow control, of user traffic 105, originating from, or terminating at the client 101, on the basis of classification information, which is provided to the server 103, via a repeated flow of updates, or notifications 104.

According to another, alternative embodiment, traffic flow classification may instead be executed on the traffic generating node 100, where the result of such a classification operation may be used by various controlling applications, such as e.g. for controlling traffic for a firewall application.

More specifically, a method for executing the proposed traffic flow classification mechanism according to any of the embodiment presented above may be described according to the simplified flow chart of FIG. 2.

In a first step 200 of FIG. 2, the proposed classification method is started at a traffic generating node. In a typical embodiment this starting procedure may comprise an initial default application to class mapping, wherein all application processes available at the traffic generating node are appointed a respective default class when they are started, such that on the basis of this information, each traffic flow associated with a specific application process will be processed according to the class that has been specified for this particular application, unless another class has been actively selected for the respective application by a user.

The described classifying mechanism comprises two different processes that are run in parallel, namely a process for managing an application to class mapping, here referred to as a class managing process, as indicated with another step 201a, and a process for uniquely identifying each traffic flow that has been generated by an application process. The latter process, which can be described as an application to signature mapping, is in this context referred to as a signature mapping process, indicated with another step 201b.

Each time any of the two managing processes mentioned above have executed any type of updating, e.g. each time an application has been started or closed, or each time a class has been updated, an updating procedure, here referred to as a classification updating process, indicated with a subsequent step 202, is executed.

The classification updating procedure 202 may be configured to generate and forward a notification, comprising updated information associated with the respective change, to any processing element that has been configured, e.g. according to a pre-configured list of nodes, to be repeatedly notified of the respective updated information for traffic flow controlling purposes.

Alternatively, this information may be updated, i.e. stored and made accessible to one or more processing elements, directly at the traffic generating node, where the updated information can be used for traffic flow controlling purposes by any of the processing elements.

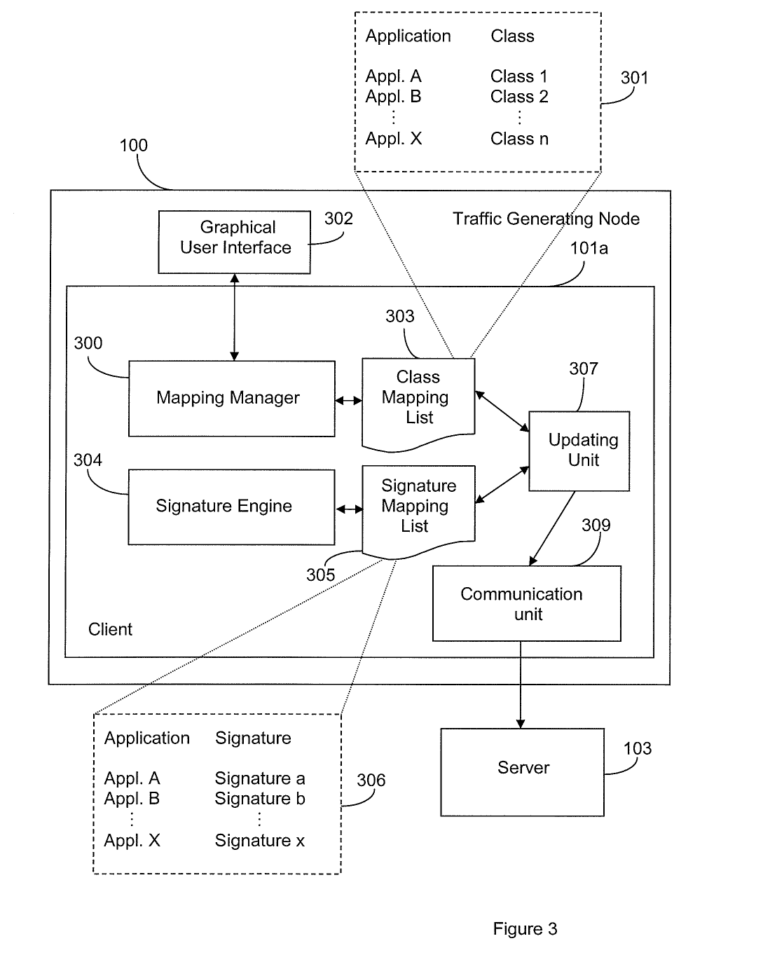

A traffic generating node comprising a client, that is configured to execute the suggested mapping mechanism according to one exemplary embodiment will now be described with reference to the block scheme of FIG. 3.

According to the described embodiment, a client 101a, that is configured to provide classification updates to distributed entities, comprises a first mapping unit, here referred to as a Mapping Manager (MM) 300, that is responsible for executing the class managing process 201a, of FIG. 2. This procedure will result in an application to class mapping, such as e.g. the one illustrated with table 301 of FIG. 3. Via a graphical user interface (GUI) 302 an end-user may specify an application to class mapping for a particular application, such as e.g. class 1 for application process A, and class 2 for application B, as indicated in the figure. Each mapping that has been executed by the mapping manager 300 is stored in a Class Mapping List 303.

The client 101a also comprises a second mapping unit, here referred to as a Signature Engine (SE) 304, which is responsible for executing the signature managing process 201b described above, with reference to FIG. 2. Signature engine 304 is responsible for maintaining an application to traffic flow mapping, i.e. to uniquely appoint a signature to a traffic flow, which has been associated with an application process once it has been recognised that the application process has started, or initiated any changes with respect to at least one socket associated with an application. The signature Engine 304 is also responsible for updating stored mapping information, such that e.g. an entry associated with a respective application is automatically removed, when an application is closed, or when a signature for any other reason, such as e.g. due to a closed socket, becomes obsolete.

A socket, also commonly referred to as a logical network exchange point, is a communication end-point that is unique to a machine communication on an Internet Protocol-based communication network. Conventional operating systems combine sockets with a running process or processes, which use the sockets when communicating with other entities over the network, and with a protocol, such as e.g. TCP or UDP, with which the processes communicate to a remote host. Information associated with sockets can therefore be used for uniquely linking an application process to the one or more traffic flows associated with the application.

The application to traffic flow mapping is maintained in a second list, here referred to as a Signature Mapping List 305. Although not explicitly indicated in this figure the two lists 303,305 may typically be maintained in separate databases, or in a common database that may be integrated with, or distributed from the mapping manager 300 and the signature engine 304, respectively.

According to this particular embodiment, a change associated with an application process that has been registered for an active or closing application, either by the mapping manager 300 or the signature engine 304 triggers another unit, referred to as an updating unit 307, to execute an updating procedure, wherein a notification is generated and forwarded to one or more servers 103, i.e. to a network node, such as e.g. a home gateway, where the classification information can be stored. In its simplest form such a notification may comprise the signature, associated with a specific application, and a class that is associated with the respective application.

The signature, which will be described in further detail below, uniquely identifies a traffic flow associated with a respective application process of a traffic generating node. The notification is forwarded to server 103 via a communication unit 309. Once at the server 103, the mapping information will typically be stored in a list, from where the accumulated, updated classification information will be accessible to one or more processing elements, which may use the classification information for traffic flow control purposes.

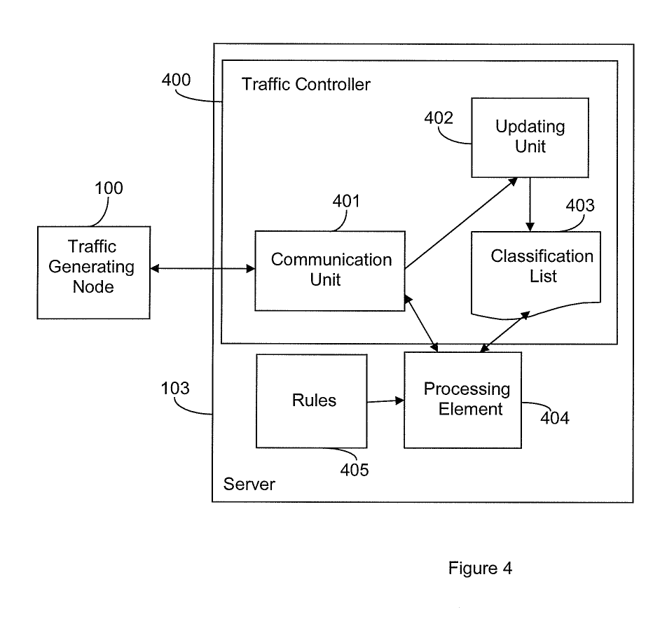

A network node 103 operating as a server, which has been configured to receive and manage traffic flow related notifications from a traffic generating node 100, such as the one described above, will now be described in more detail with reference to FIG. 4.

The Server 103 of FIG. 4 comprises a generic unit, which in this context is referred to as a Traffic Controller 400. Traffic controller 400 is configured to maintain and manage the retrieved classification information, and to make sure that any processing element 404 of server 103 will be able to access the classification information whenever required.

The server 103 receives notifications via a communication unit 401, and an updating unit 402 is configured to update a list, here referred to as a classification list 403, with the classification information provided to server 103 in the notifications. On the basis of the content of the classification list 403, one or more processing elements, in the figure represented by processing element 404 will be able to identify and control traffic flows originating or terminating at the traffic generating node 100.

It is to be understood, that once the processing element have access to the classification information, controlling of traffic flows may be executed according to any prior art controlling mechanism. The general principles for such a procedure may be exemplified by the following example.

Upon receipt of a packet to/from a traffic generating node 100, the packet is compared against the signatures of the classification list 403, by the processing element 404. If there is a match, a rule associated with that signature is performed. The rules may typically be stored in a separate storage means 405. For a firewall scenario, such rules may e.g. instruct the processing element 404 to block the respective packet.

Alternatively, different applications may have been configured to have different priorities. In this case, the respective traffic flows, each of which is associated with one of the applications, will be identified and handled by the processing element according to their priorities.

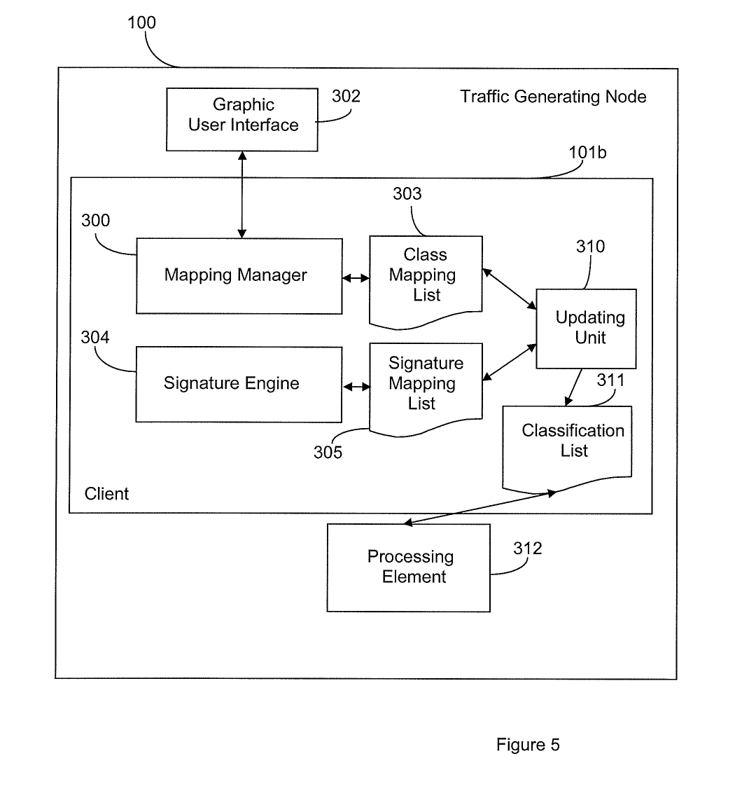

According to an alternative embodiment, the traffic generating node 100 may instead be configured to control traffic flows at the very same node as the classification is executed. Such a traffic generating node may be configured according to the block scheme of FIG. 5.

According to this alternative embodiment, a client 101b comprises an updating unit 310 which is configured to update a Classification List 311 stored at the traffic generating node 100. On the basis of the content of this list, one or more processing elements, here represented by processing element 312 of the traffic generating node, will be able to process traffic flows by executing conventional controlling tasks, on the basis of accumulated classification information. Such controlling tasks may comprise e.g. managing rate control, or firewall enforcement.

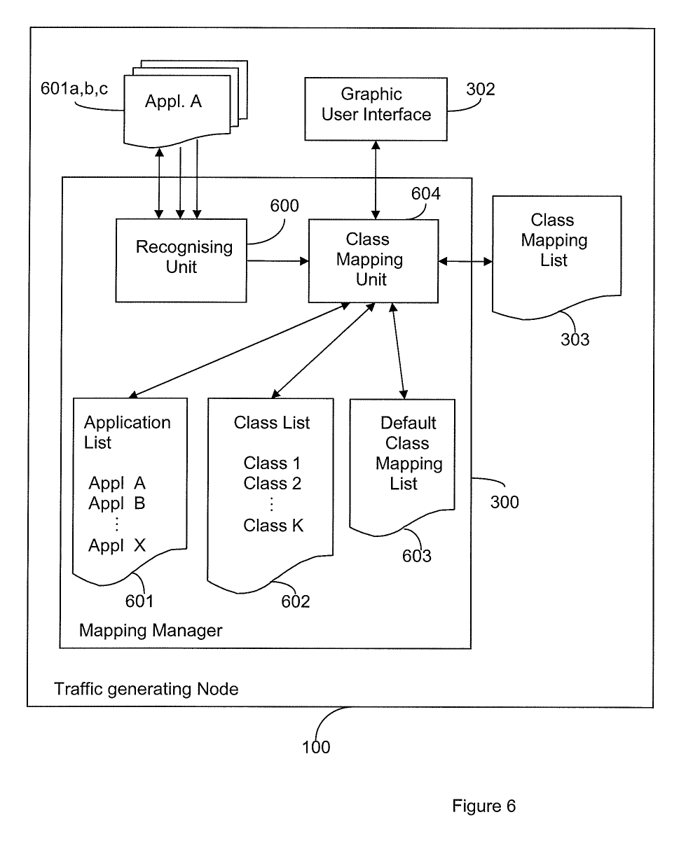

In order to give a better understanding of the intended functionality of the suggested mapping manager 300, and the associated mapping operation, an exemplified configuration of such a node, configured according to one exemplary embodiment, will now be described below with reference to the simplified block scheme of FIG. 6.

The mapping manager 300 of FIG. 6 comprises a unit, here referred to as a recognising unit 600, that is configured to keep track of any changes associated with any of applications or application processes 601a,b,c that are available at a traffic generating node 100, or more specifically, any changes or activities, of a socket, associated with the application.

According to a first embodiment, the recognising unit 600 may be configured to passively recognise a notification received from an application as an indication that the respective application has made a change with respect to at least one socket, and thus, that an application to class mapping operation is required.

According to another embodiment, the recognising unit 600 may instead be adapted to actively monitor the applications in order to be able to recognise a change that has been made to a socket by any active application. If a monitoring enabled recognising unit 600 is used, no modifications will be necessary to the applications, while the former embodiment will require that the respective applications have been configured to generate appropriate notifications to the mapping manager 300.

The mapping manager 300 will maintain a record of all applications that the recognition unit 600 is configured to keep track of, as well as all classes that will be available for classification. This information may typically be stored e.g. in an Application List (AL) 601, and a Class List (CL) 602, respectively. If priority classes are applied, the CL may comprise relevant priority classes. In its simplest form such a CL 602 may comprise a first class 1 and a second class 2, where a first class may e.g. be an indication that the respective traffic flow is to be forwarded by a processing element of a server, while traffic flows, associated with class 2 may instead be prevented from being forwarded from the server.

If instead priority classes are applied, a basic CL 602 may instead comprise a Low Priority Class and a High Priority Class. Naturally, such a list may also be extended with one or more additional classes, such as e.g. classes indicating conditional forwarding or, for priority classes, a Middle Priority Class.

The mapping manager 300 typically also comprise default settings. Such default settings may also be stored in a separate dedicated list, here referred to as a class mapping list 603, which may comprise a predefined default application to class mapping, such that a priority will always be appointed to an application, once it is started at the traffic generating node.

In response to a socket activity for any socket associated with an active or closing application that is recognised by the recognising unit 600, or to a change of class that has been activated by an end user via a GUI 302 of the traffic generating node 100, a unit, referred to as a Class Mapping Unit 604 is configured to perform an application to class mapping. According to the describe embodiment, such a mapping is executed on the basis of the content of lists 601,602,603 in combination with any activity notified, either by the recognising unit 600, or by the class mapping unit 604, wherein relevant information is obtained from the respective lists and associated information is mapped together. The resulting mapping is stored in a list, here referred to as a class mapping list 303.

As indicated above, a class may be specified for each application that is run on the traffic generating node, and, a traffic flow associated with a specific class may be handled according to conditions that have been specified for the respective class. This may e.g. enable an efficient way of conditionally filtering traffic flows associated with applications, running on the traffic generating node.

As also have been indicated above, the classification described in this document may alternatively enable end-users to prioritise applications. Thereby, processing elements having access to accumulated classification information, may be able to handle different traffic flows, each of which is associated with a specific application. As a consequence, forwarding of different traffic flows may be executed in a much more efficient way.

In addition, an end-user applying the suggested classification mechanism may also have a larger impact on how the available resources are best used when a plurality of applications are running in parallel on a traffic generating node on the supervision of the user.

One way of configuring the classification mechanism may be to provide a user interface to the end-users, where an application can be appointed a class, simply by the end-user editing an input form, e.g. as illustrated with table 301 of FIG. 3. Also priority classes may be appointed to applications in a similar manner.

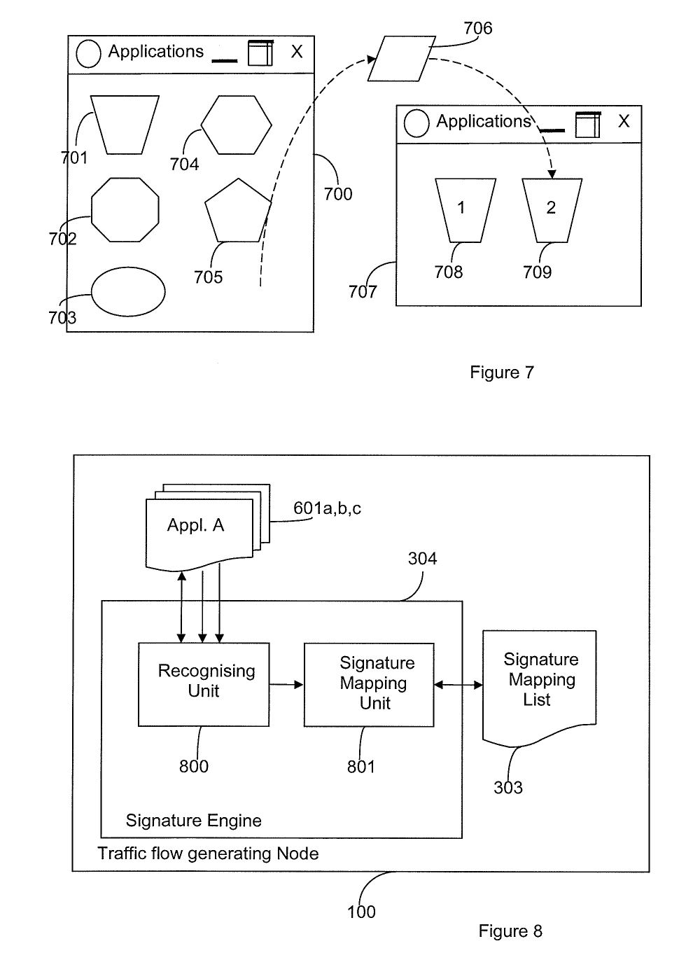

Another example, illustrating how such a prioritization task may be executed by an end-user in an even more user-friendly way will now be described with reference to FIG. 7.

FIG. 7 is an illustration of an exemplified view, comprising two windows which may typically be displayed on the screen of a graphic UI of a traffic generating node applying the suggested classification mechanism.

In a first window 700, a number of icons 701-706 are shown in a conventional manner. Another window 707 displays different priority classes as separate icons, namely priority class 1 708 and priority class 2 709, respectively, to the user.

By applying such a presentation to an end-user, the end-user may simply choose to point at a required icon, such as icon 706, as indicated in the figure. By dragging the selected icon 706 from window 700, and by dropping it at the desired priority class icon at window 707, in this case at class icon 709, the application represented by icon 706 will be appointed priority 2. As indicated above, such an updating procedure will be registered by the class mapping unit of the traffic generating node, and after a mapping operation has been commenced, the new classification information will be updated in one or more lists.

In addition to a class management process, the traffic generating node 100 also executes a signature management process, in order to be able to provide the suggested classification mechanism accordingly. Such a signature engine 304 configuration, configured according to one exemplary embodiment, will now be described in further detail with reference to FIG. 8.

The signature engine 304 of FIG. 8 has the purpose of updating and storing traffic flow related information, which in this case refers to changes made with respect to any sockets that has been associated with an application of the traffic flow generating node 100, and other relevant events that may be associated to the sockets, such as e.g. sending of packets or connection establishment.

Also the signature engine 304 comprises a recognising unit 800, such that the signature engine 304 can be triggered to update a signature mapping list 303 once a socket activity of a socket that is associated with an application of the traffic generating node has been registered by the recognising unit 800. More specifically, the recognising unit 800 is configured to keep track of when any of applications 601a,b,c have made a change with respect to any of its sockets.

The recognising unit 800 may, according to one exemplary embodiment, be configured so that it is able to recognise notifications of a changed state of an application process 601a,b,c, generated by the respective application process, according to the same general principles as was described above for mapping manager 300.

According to another embodiment, the recognising unit 800 may instead be adapted to actively monitor applications of the traffic generating node 100 for socket activities. Once it is determined that an application has made a change with respect to at least one socket, the recognising unit 800 collects relevant information about the respective socket.

On the basis of the information collected by the recognising unit 800, a signature mapping unit 801 will be configured to generate a signature, which will provide a unique linking between an application process and the socket associated with a traffic flow used by the application process. A traffic flow signature may in its simplest form be defined as the tuple:

<protocol; Source IP address; Source Port; Destination Address; Destination Port>

I.e. the signature will identify a used protocol, the source IP address of the originating node, the source address of the terminating node, while the destination address and destination port identifies where the traffic flow associated with the application is to terminate.

The result of the application to signature mapping is then stored in a signature to mapping list 303, which at any time will comprise updated mapping for active application processes. As indicated in FIGS. 3 and 5, the content of the signature mapping list will be monitored and processed accordingly by an updating unit (not shown) of the traffic generating node 100.

If the recognising unit 800 instead registers that an application process for which a mapping already exist has been closed, it will be configured to instruct the signature mapping unit 801 to update the signature mapping list 303 by instead removing the respective entry from the list.

As indicated above, changes recognised in either the priority mapping list 303, managed by the mapping manager 300, or in the signature mapping list 305, managed by the signature engine 304, will result in an updating procedure, where a classification list will be updated, either in the traffic generating unit 100, or in a server 103 that is configured to repeatedly receive classification information from the traffic generating node 100, and to store accumulated classification information.

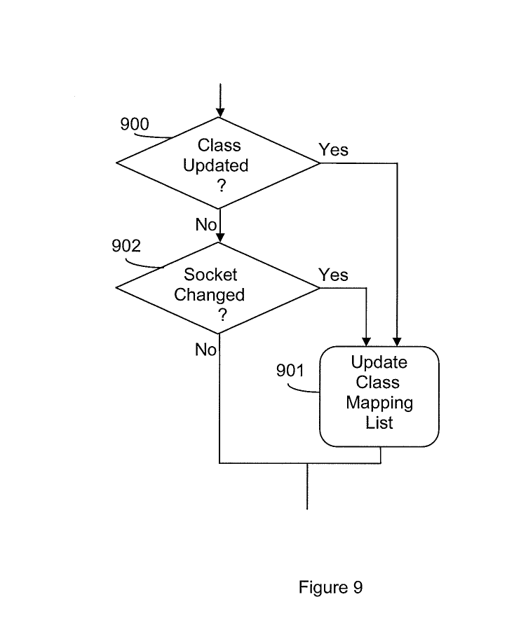

A method describing how the priority management process according to the alternative embodiment described above may be executed will now be presented with reference to the flow chart illustrated with FIG. 9.

In a first step 900 of FIG. 9 it is determined by a recognising unit whether a class has been updated or not. If this is the case, a class mapping list is updated, as indicated with a step 901. If, however, this is not the case, it is instead determined whether any change has occurred to a socket, as indicated in a next step 902. If this is the case, the class mapping list is also updated, possibly on the basis of a default mapping.

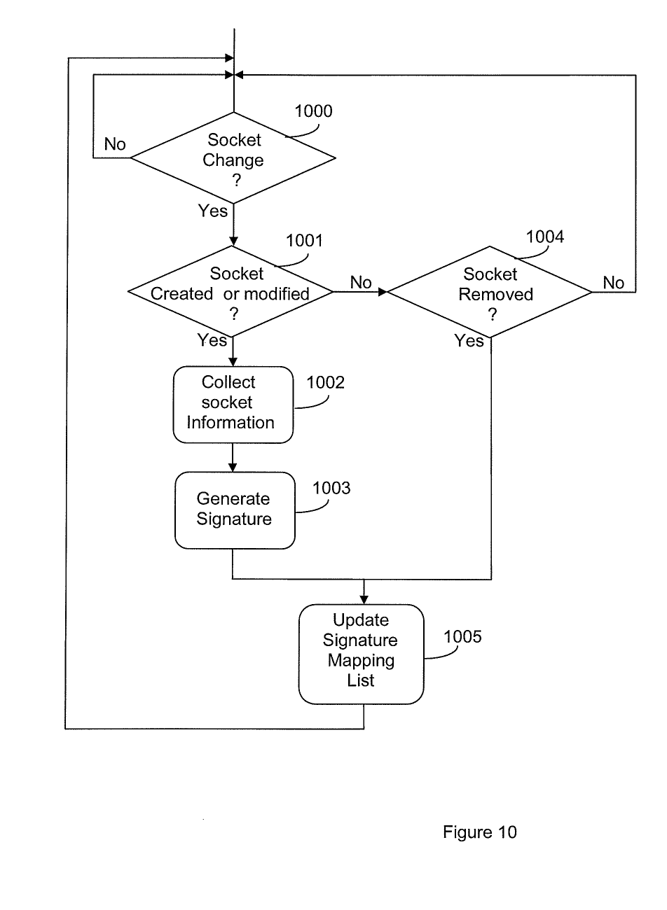

The previously mentioned signature mapping process, accompanying the class mapping process, may be described with reference to the flow chart of FIG. 10. According to FIG. 10 it is first determined whether any change related to any socket has occurred in a step 1000. If this is the case, it is then determined whether a new socket has been created, e.g. due to the starting of an application, in another step 1001. If a socket has been created, information related to that socket which is required for generating a signature, is collected, as indicated with a step 1002, and in a subsequent step 1003, the signature is generated. If, however no socket has been created, it is determined whether a socket has been removed, e.g. if an application has been closed. This is illustrated with a step 1004. If either a socket has been created or removed, the signature mapping list is then updated in a next step 1005, after which the described procedure is repeated, starting again at step 1000.

A corresponding method adapted to be executed at a server may be described with reference to another flow chart, in order to further clarify how classification information may be updated and used by a server, according to one exemplary embodiment.

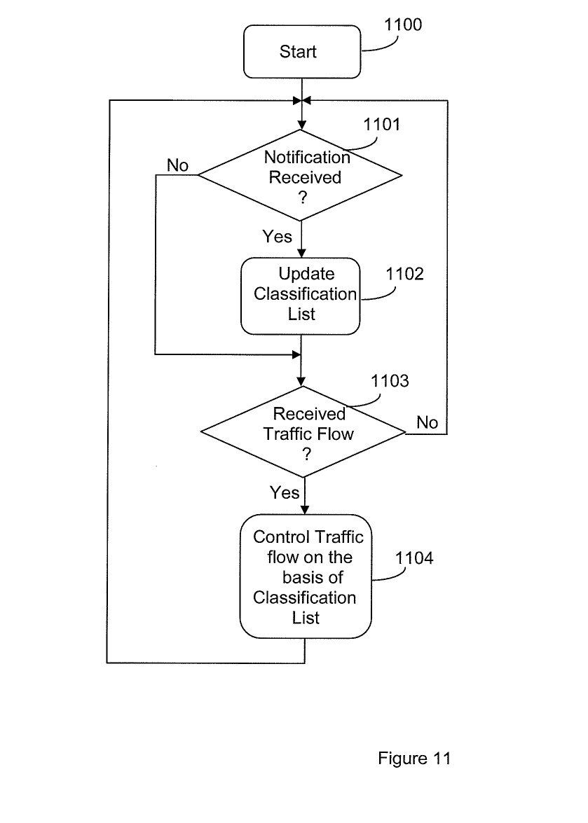

FIG. 11 refers to a repeating process for maintaining a classification list of a server updated with accumulated signature to class mapping information, where the server is being updated from a traffic generating node, and where one or more processing elements may use the content of such a list for controlling traffic flows that are associated with an application process that is running on the traffic generating node.

In a first step 1100 a classification information updating and controlling process is started at the server. In a next step 1101 it is determined whether a notification has been received from the traffic flow generating node. If a notification has been received, the content of this notification is updated in a classification list, as indicated in a step 1102. The server will be able to control the respective traffic flows on the basis of the information retrieved via the notifications. In a next step 1103 it is determined whether a traffic flow to, or from, the flow generating node has been identified by the server. If this is the case, the traffic can be controlled on the basis of the information retrieved from the classification list, as indicated with a final step 1104, before the procedure is repeated, starting at step 1100.

Throughout this document, the terms used for expressing functional devices, entities or nodes, such as e.g. “traffic generating node”, “mapping manager”, “signature engine” and “traffic controller” “priority mapping unit”, as well as various units of the described devices, entities or nodes, such as e.g. “updating unit”, “signature mapping unit” and “priority mapping unit” should be interpreted and understood in its broadest sense as representing any type of devices, entities, nodes or units, respectively, which have been configured to process and/or handle correlation data, according to any of the general principles presented in this document.

In addition, while the described method and nodes have been described with reference to specific exemplary embodiments, the description is generally only intended to illustrate the inventive concept and should not be taken as limiting the scope of the described concept, which is defined by the appended claims.

### ABBREVIATION LIST

ADSL Assymetric Digital Subscriber Line
BRAS Broadband remote Access Server
MM Mapping Manager
SE Signature Engine
QoS Quality of Service

1. A method of classifying traffic flows in a traffic generating node, each traffic flow being associated with an application process running on said traffic generating node, the method comprising:
performing a first mapping operation, such that an application process is linked to a class in response to having registered a selection or change of class for said application process,
performing a second mapping operation, such that an application process is linked to a signature that uniquely identifies a traffic flow and an associated socket in response to having registered an activity for said socket, and
activating a third mapping operation, such that a respective signature is linked to the respective class in response to having registered an activity associated with said first or second mapping operation that involves an active or closing application process,
thereby enabling accumulation of information on said linking of signature to class, which can be used for controlling said traffic flows.

2. The method according to claim 1, wherein said first mapping operation comprises a step of maintaining said mapping in a first list, and said second mapping operation comprises a step of maintaining said mapping in a second list.

3. The method according to claim 1, wherein said first mapping operation is executed according to a default classification.

4. The method according to claim 1, wherein said first mapping operation is executed in response to a user interaction.

5. The method according to claim 4, wherein said user interaction comprises the steps of:
dragging an icon that corresponds to an application to a class related symbol or between two different class related symbols on a user interface, and
dropping said icon on a class related symbol that represents a required class.

6. The method according to claim 1, wherein said class is associated with at least one rule, specifying at least one condition associated with a traffic flow that is linked to said class.

7. The method according to claim 1, wherein said class is associated with a priority, specifying how a traffic flow that is linked to said class is to be prioritized.

8. The method according to claim 1, wherein said second mapping operation comprises the steps of:
collecting information associated with said activated socket,
generating a signature associated with said application process on the basis of said collected information, and storing said signature in the second list together with an identifier identifying said application process, in response to having recognised a created socket, or
removing an entry from said second list, in response to having recognised that a socket associated with an application process has been removed.

9. The method according to claim 1, wherein said signature comprises: protocol, the source IP address, the source port, the destination IP address and the destination port, associated with said socket.

10. The method according to claim 1, wherein a socket activity is registered by monitoring the associated application process.

11. The method according to claim 1, wherein a socket activity is registered in response to receiving a notification of such an activity from the associated application process.

12. The method according to claim 1, wherein said third mapping operation comprises the step of:
storing a mapping in a third list, in case a new mapping has been executed or a present mapping has been updated, or
removing an entry from said third list, in case a socket has been closed, or a class has been cancelled for an application process,
thereby enabling accumulation of information on said linking of signature to class, which can be used for classifying said traffic flows.

13. The method according to claim 12, further comprising the step of:
controlling at least one traffic flow on the basis of accumulated information stored in said third list.

14. The method according to claim 1, wherein said third mapping operation comprises the further steps of:
generating a notification comprising the signature to class linking or an indication that a linking has been removed from said first and second list,
transmitting said notification to at least one server, thereby enabling accumulation of information on said linking of signature to class at said server

15. A method at a server comprising at least one processing element for controlling at least one traffic flow on the basis of linked signature to class information accumulated, according to claim 14.

16. A traffic generating node for classifying traffic flows, each traffic flow being associated with an application process running on said traffic generating node, comprising:
a mapping manager adapted to perform a first mapping operation, such that an application process is linked to a class in response to the mapping manager having registered a selection or change of class for said application process,
a signature engine adapted to perform a second mapping operation, such that an application process is linked to a signature that uniquely identifies a traffic flow and an associated socket in response to the signature engine having registered an activity for said socket, and
an updating unit adapted to activate a third mapping operation, such that a respective signature is linked to the respective class in response to the updating unit having registered an activity associated with said first or second mapping operation that involves an active or closing application process.

17. The traffic generating node according to claim 16, wherein said mapping manager is adapted to maintain mappings in a first list, and said signature engine is adapted to maintain mappings in a second list.

18. The traffic generating node according to claim 16, wherein said mapping manager is adapted to execute a mapping according to a default classification.

19. The traffic generating node according to claim 16, wherein said mapping manager is adapted to execute a mapping in response to a user interaction.

20. The traffic generating node according to claim 19, wherein said node further comprises a graphical user interface adapted to register a requested classification of an application process by registering that an icon that corresponds to an application to a class related symbol has been dragged to or between two different class related symbols on a user interface, and that said icon has been dropped on a class related symbol that represents a required class.

21. The traffic generating node according to claim 16, wherein said signature engine comprises:
a recognising unit adapted to collect information associated with said activated socket,
a signature mapping unit adapted to generate a signature associated with said application process on the basis of said collected information, and to store said signature in the second list together with an identifier identifying said application process, in response to the signature mapping unit having recognised a created socket, or
to remove an entry from said second list, in response to the signature mapping unit having recognised that a socket associated with an application process has been removed.

22. The traffic generating node according to claim 16, wherein said node is adapted to register a socket activity by monitoring the associated application process.

23. The traffic generating node according to claim 16, wherein said node is adapted to register a socket activity in response to having received a notification of such an activity from an associated application process.

24. The traffic generating node according to claim 16, wherein said updating unit is adapted to:
store a mapping in a third list, in response to having recognised that a new mapping has been executed or that a present mapping has been updated, or
to remove an entry from said third list, in response to having recognised that a socket has been closed, or that a class has been cancelled for an application process.

25. The traffic generating node according to claim 24, comprising at least one processing element, said processing element being adapted to control at least one traffic flow on the basis of accumulated information stored in said third list.

26. The traffic generating node according to claim 16, wherein said updating unit is adapted to
generate a notification comprising the signature to class linking or an indication that a linking has been removed from said first and second list, and to
transmit said notification to at least one server, thereby enabling accumulation of information on said linking of signature to class at said server.

27. A server comprising at least one processing element, said processing element being adapted to control at least one traffic flow on the basis of linked signature to class information accumulated, according to claim 26.
